(19) United States
(12) Patent Application Publication
(10) Pub. No.: US 2002/0147557 A1
(43) Pub. Date: Oct. 10, 2002

(54) Method of compensating for work piece distortions and machine errors

(76) Inventor: Kenny Trinh, Westminister, CA (US)

Correspondence Address: Irving Keschner, Suite 1150, 21515 Hawthorne Boulevard, Torrance, CA, 90503, US

(21) Appl. No.: 09/909,070

(22) Filed: Jul. 20, 2001

Related U.S. Application Data
(60) Provisional application No. 60/264,835, filed on Jan. 30, 2001.

(51) Int. Cl. G01P 21/00

(52) U.S. Cl. 702/95

(57) ABSTRACT

A method for correcting errors on a work piece comprising the steps of defining a compensating rectangle, inputting the actual rectangle and obtaining and applying the compensating values that satisfy the actual coordinate system. A compensating rectangle is a rectangle inside a work piece with one side parallel to one axis of a machine coordinate, three or four points being required to define the compensating rectangle. An actual rectangle is a rectangle inside a work piece, the four corner points being the actual or estimate reading values obtained from inspection of the compensating rectangle. The coordinate system values are the numbers that can be applied to a point to move it from one location to a different location in one coordinate system. The corner points of the compensating rectangle are moved so that they best fit the corner points of the actual rectangle.

### RELATED APPLICATION

This application is based on Provisional Application No. 60/264,835, filed Jan. 30, 2001.

### BACKGROUND OF THE INVENTION

1. Field of the Invention

The present invention relates to controlling manufacturing processes and, in particular, to a method of compensating a manufacturing process for errors introduced into a work piece by prior manufacturing processes.

2. Description of the Prior Art

During a multistep manufacturing process, errors in the position of features on the work piece may develop; i.e., the actual location of a feature may differ from its nominal position. The errors may be caused by errors in the machine creating the feature or by work piece shrinkage, expansion or shift due to a change in temperature or pressure. An error in one step of the process will effect the accuracy of the operations in subsequent processes. For example, the process of making printed circuit boards involves the steps of preparing the artwork, layout, lamination, drilling, and plating. If the artwork machine and the lamination press have errors, the drilling machine might drill holes at the wrong locations and the plating machine operation will short the circuits formed in the printed board.

Every machine has limitations in its accuracy; the major errors are normally classified as pitch, yaw, roll, straightness and squareness errors.

Due to temperature variations or pressure, work pieces may become distorted as they progress through the steps of a manufacturing process. The errors may not be uniform over the entire work piece. The rate of change is non-linear and the moving direction is unpredictable throughout the entire work piece. A region on the work piece may stress more than another region on the same work piece. For example, two points on a flat panel separated by a distance of exactly one inch apart may no longer be the same distance apart after the work piece is heat treated.

In a two dimensional work space, there are five major positioning errors: squareness errors, yaw errors, scale errors, skew errors, and offset errors. FIG. 1 illustrates the effect of these error types on an ideal, or nominal, rectangle 6 (FIG. 1(a)) having edge points A, B, C, D and E. Squareness errors occur when the X-axis and Y-axis of a two dimensional coordinate system are not perpendicular. The effect of this type of error is to change a rectangle in a work piece 8 to a parallelogram 10 (FIG. 1 (b). Yaw errors occur when an axis in a coordinate system is not straight. A yaw error will change a rectangle in work piece 8 to a trapezoid 12 (FIG. 1(c)) and its effect is to lengthen or shorten a side of the rectangle in work piece 8. Skew errors occur when a point or a group of points is rotated about another point in the plane containing the group of points. The effect of a skew error is to rotate a rectangle 14 in work piece 8 about a point in the plane (FIG. 1(d)). Scale errors (FIG. 1(e)) occur when an axis in a coordinate system is stretching or shrinking. The effect of scale error will lengthen or shorten two sides of rectangle 16 in work piece 8 (FIG. 1(e)). Offset errors occur when the coordinate of a point or a group of points have shifted by a fixed value. The effect of an offset error is to move rectangle 18 in work piece 8 to a different location in the same coordinate system (FIG. 1(f)).

At every step in a process each feature in the work piece can be described by two sets of coordinates, the nominal coordinates obtained from the original design and the actual coordinates that result from the non-ideal manufacturing processes. The actual coordinates can be obtained by physical inspection of the work piece after the completion of each manufacturing step (i.e. using a camera or x-ray technique). If the next manufacturing step requires the actual coordinates, the machines commands must be modified from those required by the nominal coordinates to those appropriate for the actual coordinates.

Conventionally, the change of the coordinates takes place at the machine level where the actual coordinates are measured and processed on the same machine, and fed to the servo system for positioning.

U.S. Pat. No. 5,661,654 to Nagashima discloses a system for correcting six degree-of-freedom offset errors caused by using a fixture for fixing a work piece to be operated on by a machine without requiring a modification to the machine's control program. This method suffers from the disadvantages that a complex additional component of the machine is required and the corrections are constant throughout the work piece.

U.S. Pat. No. 5,864,776 to Warren et al. discloses a technique for detecting a placement error by using detected infrared energy emissions. U.S. Pat. No. 5,696,590 to Makita discloses a system which controls the position of a semiconductor manufacturing apparatus by correcting a generated control signal.

What is thus desired is to provide a process wherein machine positioning errors are quickly and simply corrected without utilizing the relatively expensive and complex conventional techniques currently available.

### SUMMARY OF THE PRESENT INVENTION

The present invention provides a simplified and inexpensive method for correcting an error on a work piece, the method comprising the steps of defining compensating rectangles and storing them in a list of rectangle sets, inputting the actual rectangles, and then obtaining and applying the compensating values that satisfy the actual coordinate system to every rectangle set in the list. The compensating values are numbers that can be applied to a point to move it from one location to a different location in a coordinate system.

The present invention thus provides a simple and cost effective technique that modifies the software that controls machine processes in a manner so that positioning errors are easily and automatically corrected.

### DESCRIPTION OF THE DRAWINGS

For a better understanding of the invention as well as other objects and further features thereof, reference is made to the following description which is to be read in conjunction with the accompanying drawings wherein:

FIGS. 1(a)-1(f) illustrate five major types of errors that may occur in a two dimensional workspace;

FIG. 2 depicts the data structure used to store one rectangle set;

FIG. 3 shows a flow chart of the general operation of the invention;

FIG. 4 is a schematic of a work piece with features positioned according to the original design;

FIG. 5 is a schematic of a work piece with features positioned after a manufacturing operation;

FIG. 6 illustrates the relationship between the compensation rectangle and the actual rectangle;

FIG. 7 is a flow chart illustrating the process of defining a compensation rectangle;

FIG. 8 is a flow chart illustrating the sequence for storing an actual rectangle in memory;

FIG. 9 is a table depicting the arrangement of memory arrays for a compensating rectangle and an actual rectangle;

FIG. 10 is a flow chart illustrating the sequence of steps to associate points in the compensating rectangle to points in the actual rectangle;

FIG. 11 is a table showing the relationship between the number of point errors and the type of corrections applied;

FIG. 12 is a flow chart illustrating the calculation and application of squareness errors;

FIG. 13 is a flow chart illustrating the calculation and application of yaw errors;

FIG. 14 is a flow chart illustrating the calculation and application of skew errors;

FIG. 15 is a flow chart illustrating the calculation and application of scale errors; and

FIG. 16 is a flow chart illustrating the calculation and application of offset errors.

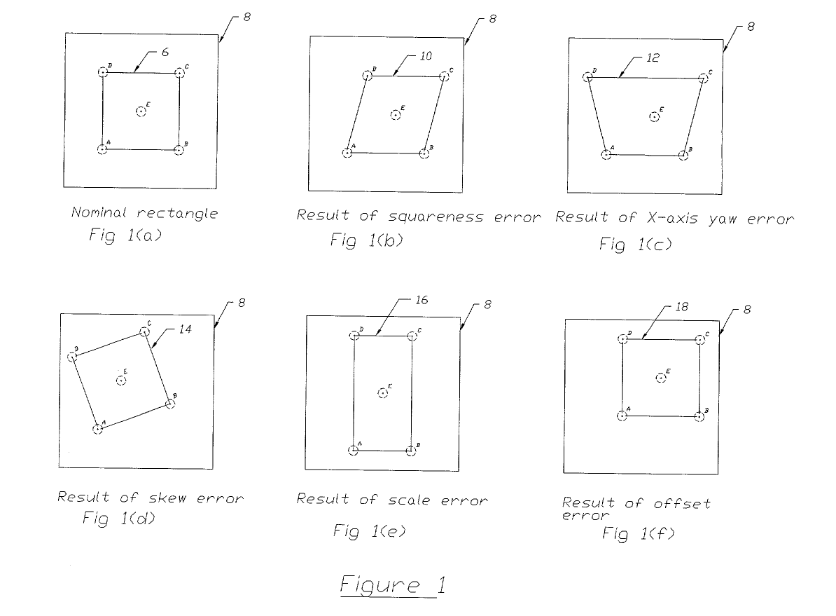

### DESCRIPTION OF THE INVENTION

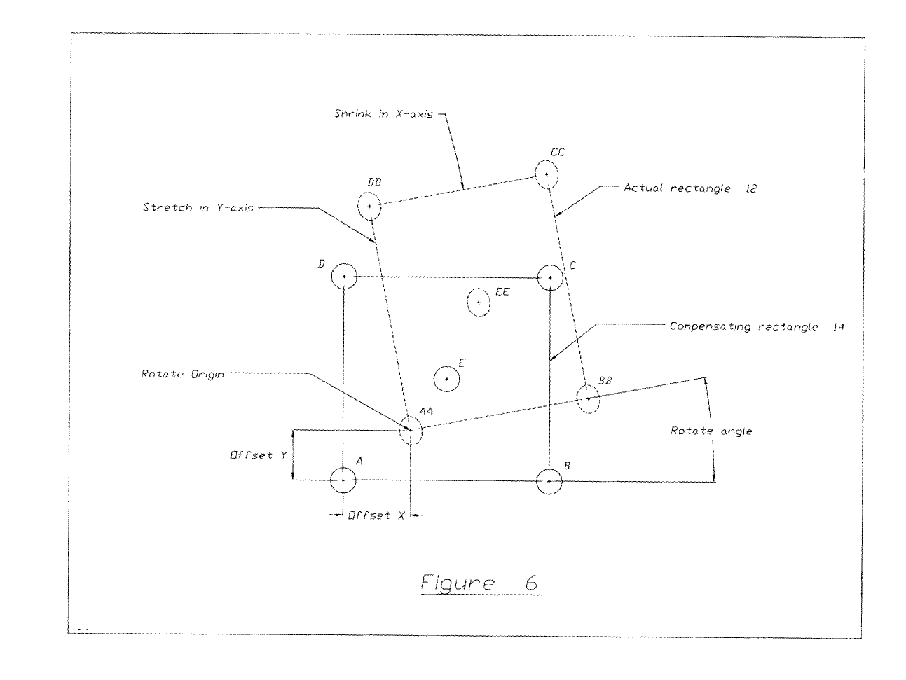

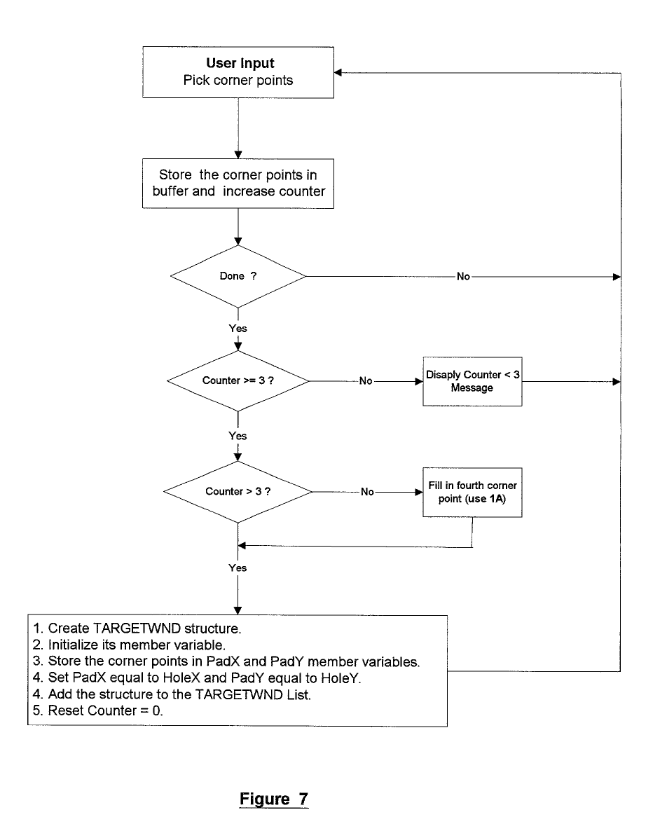

In accordance with the teachings of the present invention, a compensating rectangle 14 (see FIG. 6) is defined as a rectangle with one side parallel to one axis of the machine coordinate system inside a work piece. The compensating rectangle 14 is identified with four corner points A, B, C and D. Within the work area, the compensating rectangle 14 has no limitation in size, location or quantity. Also a compensating rectangle can be nested or overlapped by another compensating rectangle. Moreover, an actual rectangle 12 (FIG. 6) is defined as an rectangle with four corner points that reflect the actual readings or estimated values obtained from inspection of the compensating rectangle 14. For an example, the corner point AA of the actual rectangle 12 is the actual reading of the corner point A of the compensating rectangle 14; the corner point BB of the actual rectangle 12 is the actual reading of corner point B of the compensating rectangle 14 and the same principle applies for corner point CC and DD.

From the definition of the compensating rectangle and the actual rectangle, there must be an actual rectangle corresponding to one compensating rectangle. A compensating rectangle and its corresponding actual rectangle is called a compensating rectangle set. For example, the compensating rectangle 14 and the actual rectangle 12 is one compensating rectangle set.

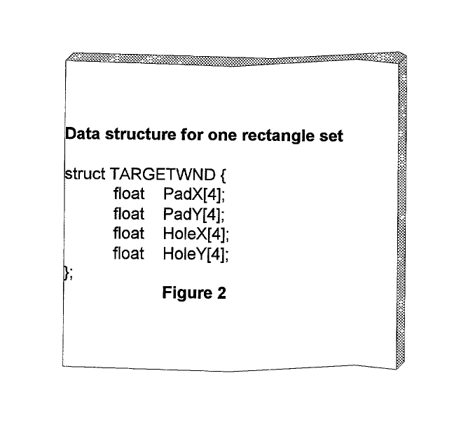

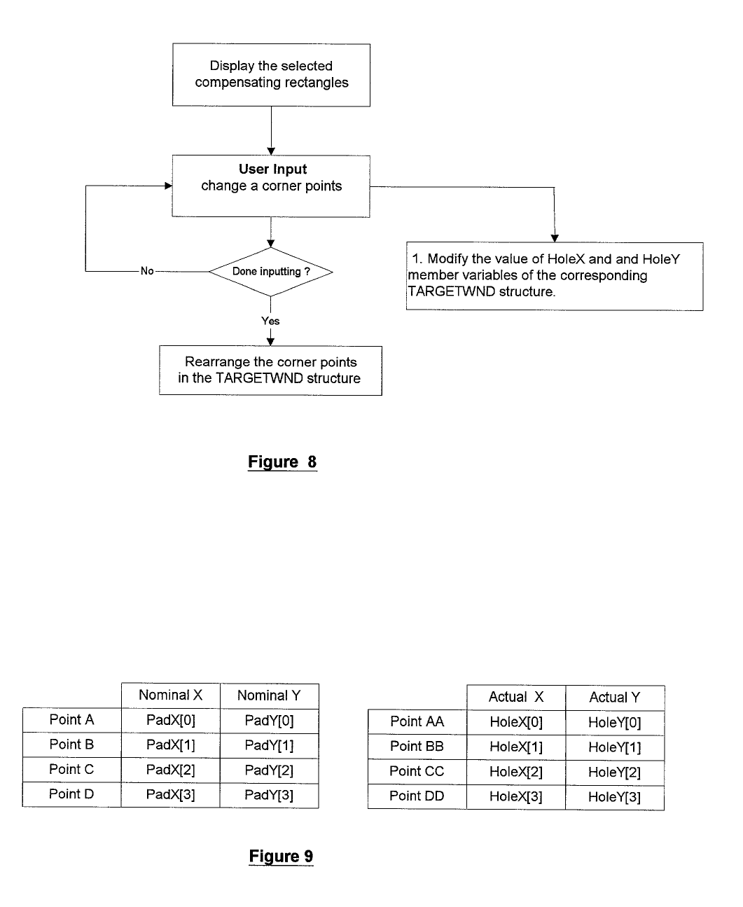

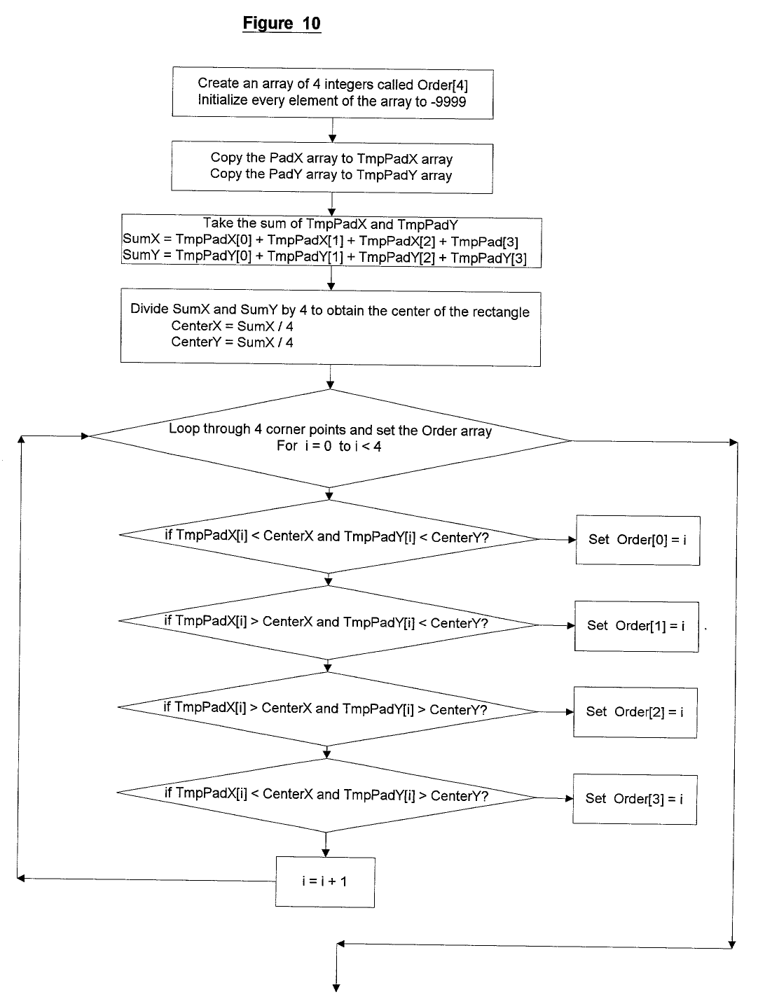

Since a rectangle can be stored in memory by the coordinates of its four corner points and a point consists of X-axis and Y-axis coordinate values, a compensating rectangle set can be stored in a data structure TARGETWND (see FIG. 2). The coordinates of four corner points of a compensating rectangle are stored in PadX and PadY floating point number arrays. PadX stores the X-axis coordinate only, PadY stores the Y-axis coordinate only and so are HoleX and HoleY. The order of the number array represents the corner point. For example, PadX[0] and PadY[0] are the X and Y coordinate of the first corner point of the compensating rectangle. HoleX[1] and HoleY[1] are the X and Y coordinate of the second corner point of the actual rectangle and so on. The compensating rectangle 14 and the actual rectangle 12 can be stored in a TARGETWND data structure as shown in FIG. 9.

Since a part program can have multiple compensating rectangles, the order of compensating execution is important. The order of the compensating execution is the order of the compensating rectangles that a user defines, first in, first out. For example, a compensating rectangle R1 is defined first, R2 is defined next, then R3 is defined last. The compensating will start with the rectangle R1, then R2 then R3. In order to achieve this operation, a link list of compensating rectangle sets is required. A link list of compensating rectangle sets is a collection of compensating rectangle sets in memory. The very fist item that is inserted to the link list is called the head item and the last item that is inserted is called the tail item. The link list can grow longer as compensating rectangle sets are added to the tail of the list. Also, the link list can be visited from head to tail. In other words, the head item must be visited first before the next item in line and so on until the last item.

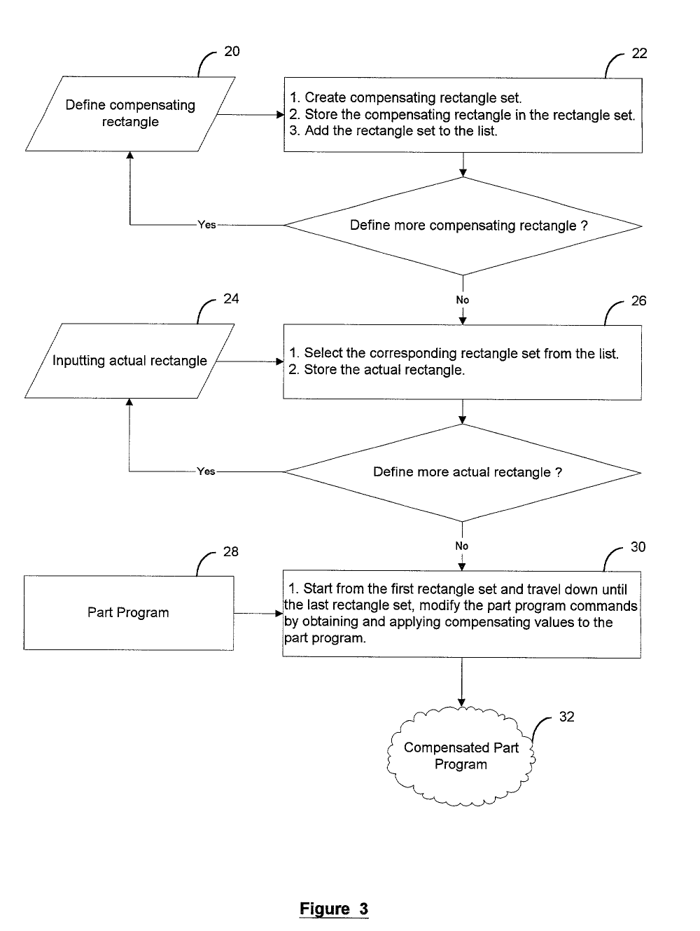

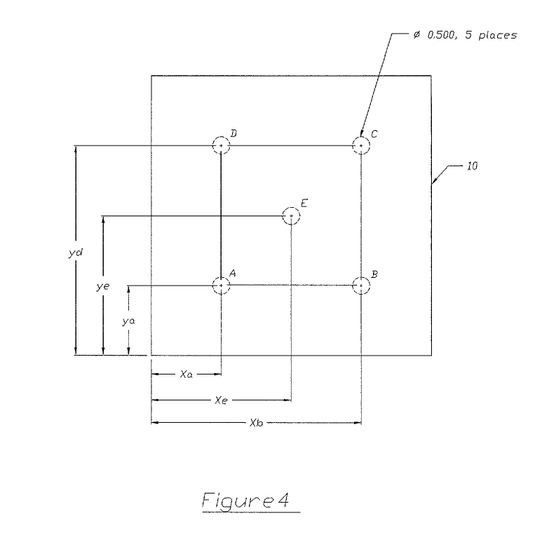

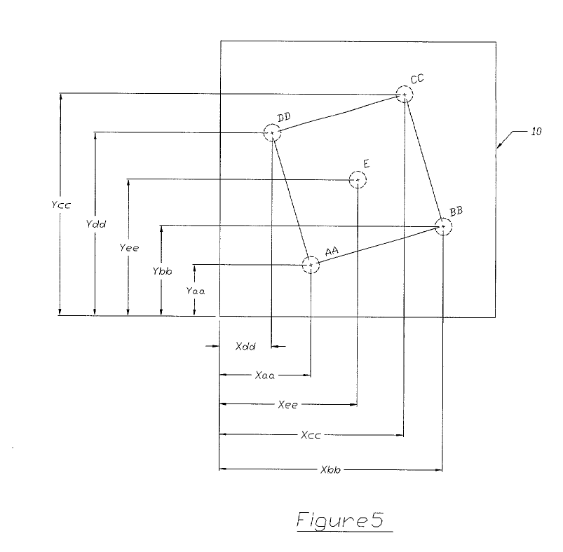

FIG. 3 is a block diagram/flow chart of the present invention. In particular, a compensating rectangle 20 is first defined and the compensating rectangle is stored in a link list (block 22). The actual rectangle 24 is stored in the link list (block 26). The part program (block 28) is then operated on (block 30) by the compensating values of obtained from the generated list (block 26) for every compensating rectangle set in the link list to thereby generate the compensated part program (block 32). A conventional microprocessor can be utilized to implement the program of the present invention.

FIG. 4 shows a portion of a simple circuit board 10 that has, for example, five copper pads laminated in between two dielectric layers. A original part program for drilling holes in the center of the pads is utilized (this feature is not set forth since it is conventional). However, the coordinates of the pads typical change after the lamination process. The actual coordinates of the pads after the lamination process are shown in FIG. 5.

The error correction method employed in the present invention is as follows: the compensating rectangles where the error correction will be applied is defined and stored; the actual rectangle is inputted, and the compensation values are obtained and applied to the original program (FIG. 3). The notation conventions that are used are:

A(X,Y) means a point, “A”, having the coordinates of X and Y.

MIN(X1, . . . , Xn) is a function that takes X1, . . . Xn as input variables and returns the minimum value among X1, . . . Xn.

Max(X1, . . . , Xn) is a function that takes X1, . . . Xn as input variables and returns the maximum value among X1 . . . Xn.

Abs(X) is a function that takes a number X as input variable and returns the absolute value of X.

First Step: Defining the Compensating Rectangle.

Corner points can be picked in any order. For example, the compensating rectangle 14 (FIG. 6) can be defined with four corner points, A, B, C, D or D, B, A, C or any other combination. Three or four corner points are required to define the compensating rectangle. The selected points are assumed to be the corner points of the rectangle. If three points are given to define a compensating rectangle 14 (FIG. 6), the fourth corner point of the rectangle is automatically added to the opposite corner of the three given points using the following shown in formula 1A, Table I (note that all the formulas referred to hereinafter will be set forth in Table I). The software flow chart shown in FIG. 7 explains the process of defining a compensating rectangle and storing it in memory.

Second Step: Inputting the Actual Rectangle.

An actual rectangle can have five possible scenarios with respect to its nominal rectangle. The first, no corner point variation scenario means all corner points of the actual rectangle are exactly the same as the four corner points of the compensating rectangle and no error occurs. The second or one corner point variation scenario means only one corner point of the actual rectangle is varied from the matching corner point of the compensating rectangle. The third or two corner point variation scenario means two corner points of the actual rectangle are different from the matching corner points of the compensating rectangle. The same concept applies to the fourth, or three corner point variation, scenario and the fifth or four corner point variation. To simplify the process of inputting an actual rectangle, the actual rectangle is initially set equal to the compensating rectangle, then the actual rectangle can be modified with no corner point, one corner point, two corner points, three corner points, or four corner points by changing their values. The software flow chart shown in FIG. 8 explains how the actual rectangle is stored in memory.

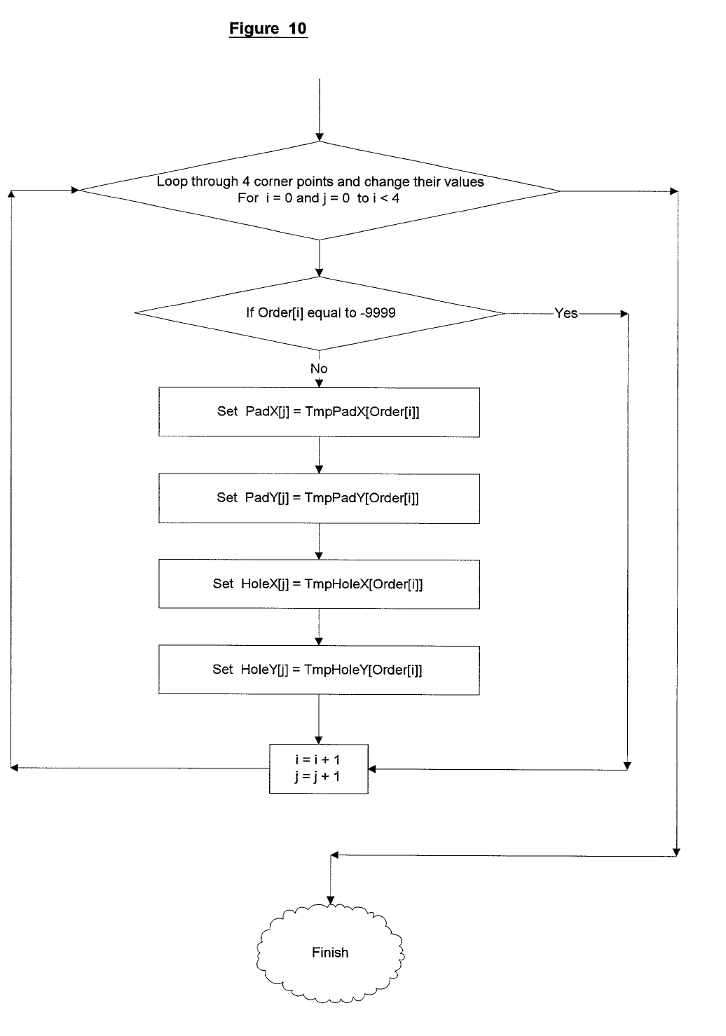

Since the corner points of the compensating rectangle and actual rectangle are defined in any order and stored in the PadX, PadY, HoleX, HoleY number arrays, the order of the arrays does not represent a unique geometrical relationship. This creates complexity in the future calculation. In order to provide simplicity, consistency and flexibility, the coordinates of the corner points in the arrays can be arranged. When a user finishes inputting the actual rectangle, all corner points of both compensating rectangle and actual rectangle are arranged so that the HoleX[0], HoleY[0], PadX[0], PadY[0] contain the coordinates of the lower left corner points; the HoleX[1], HoleY[1], PadX[1], and PadY[1] contain the coordinates of the lower right corner points; the HoleX[2], HoleY[2], PadX[2], and PadY[2] contain the coordinates of the upper right corner points; the HoleX[3], HoleY[3], PadX[3], and PadY[3] contain the coordinates of the upper left corner points. FIG. 9 shows how the compensating rectangle 14 (FIG. 6) and actual rectangle 12 (FIG. 6) are stored in memory arrays after rearrangement; the flow chart shown in FIG. 10 explains the algorithm of arranging corner points for both compensating rectangle and actual rectangle. For the convenience of further explanation, the PadX[0] and PadY[0] refers to the nominal X and Y coordinates of the lower left corner point of the compensating rectangle. HoleX[0] and HoleY[0] refers to the X and Y coordinates of the actual rectangle. PadX[1] and PadY[1] are the coordinates of the lower right corner points. PadX[2], PadY[2], HoleX[2], and HoleY[2] are the coordinates of the upper right corner points; and PadX[3], PadY[3], HoleX[3], and HoleY[3] are the coordinates of the upper left corner points. Moreover, a point program enclosed by the circumference of a compensating rectangle is called a target point of that compensating rectangle. For example, point E (FIG. 6) is a target point of the compensating rectangle 14.

Third Step: Obtaining the Compensating Values and Applying them to the Original Program.

Compensating values are numbers, organized in groups, that can be applied to a point to move it from one location to a different location in a coordinate system. Compensating values can be categorized in five groups, namely, offset, skew, scale, squareness and yaw. Each group contains related numbers than can only be used to compensate for one type positioning error. The number of groups that can be obtained for one compensating rectangle depends on the number of corner point variations. For example, a compensating rectangle with two corner point variations would have skew error and offset error compensating values. From a minimum of zero point variation to a maximum of four point variation, more input of actual corner points yields better results because more error type can be compensated.

The actual compensating process takes place at this step. The coordinates of every target point of a compensating rectangle are modified by applying the compensating values which is obtained from the compensating rectangle set. In other words, once a group of compensating values are obtained, it must be applied to every target point in the compensating rectangle before the next group of compensating rectangles can be calculated and applied. Among the five groups of compensating value, squareness has the most executing priority; yaw has second executing priority, skew has the third executing priority, scale has the fourth executing priority and the offset has the least executing priority. For example, a compensating rectangle with four corner point variation will be compensated in the order of squareness error, yaw error, skew error, scale error, and offset error. FIG. 11 shows the possible error correction based on the number of corner point variations, and the executing priority of each group compensating values.

Squareness Error Compensation:

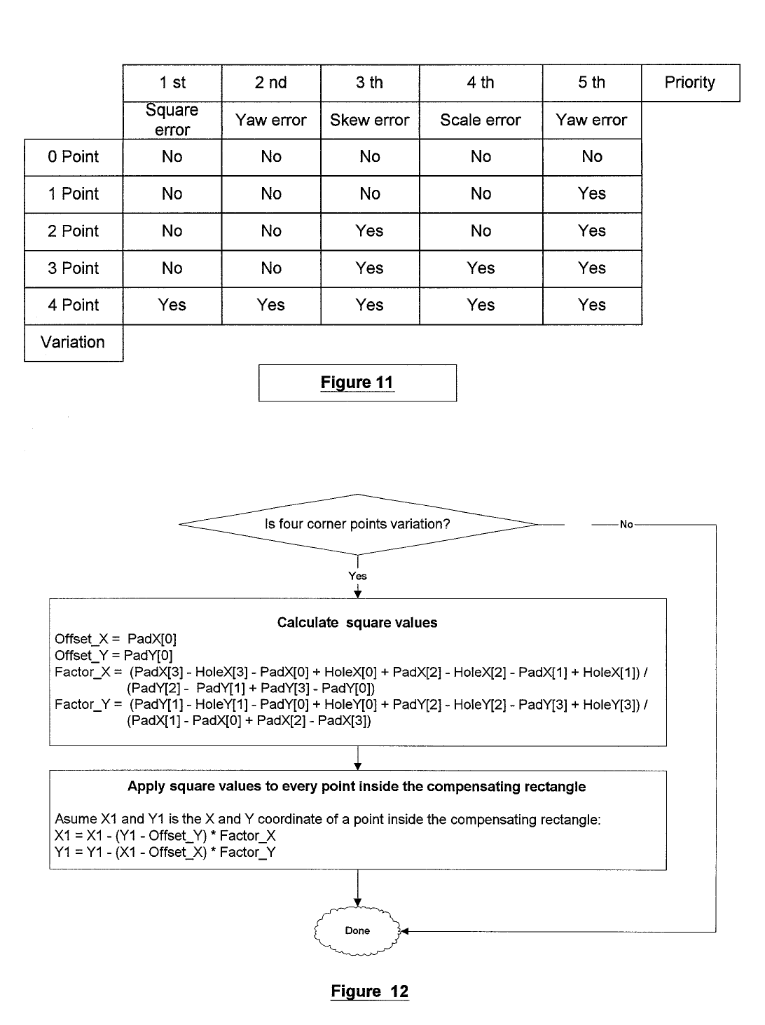

The squareness error compensation requires a four point variation. The compensating values for squareness include a Offset_X, Offset_Y, Factor_X and Factor_Y. These values can be obtained using formula 2A. The squareness compensating values must be applied to every target point. Assuming X1 and Y1 are the X and Y coordinates of a target point, formula 3A shows the method of applying squareness values. Both steps of obtaining squareness compensating values and applying them to the part program are shown in the software flow chart of FIG. 12.

Yaw Error Compensation:

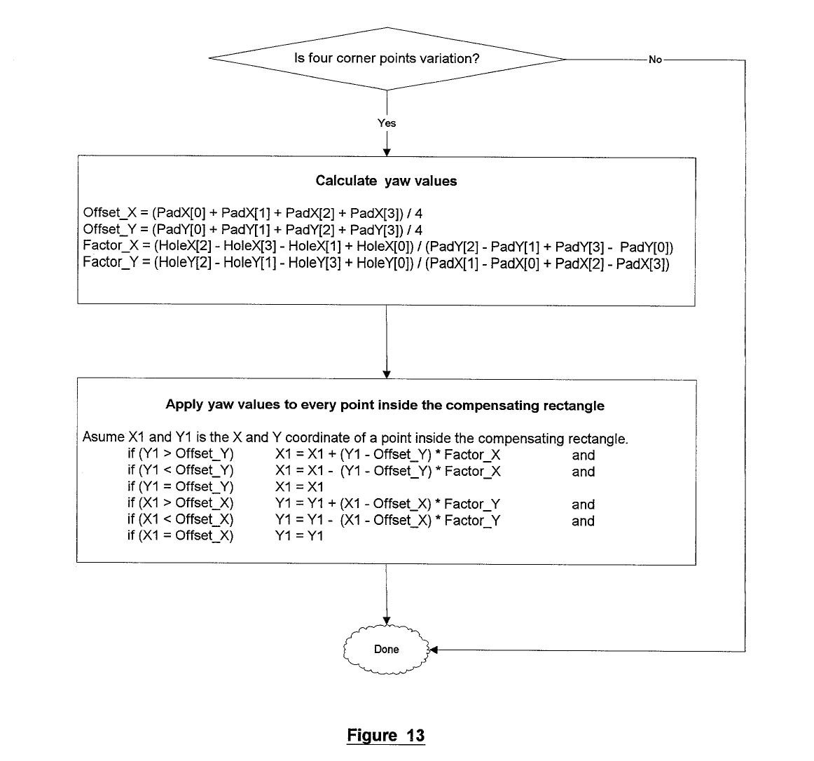

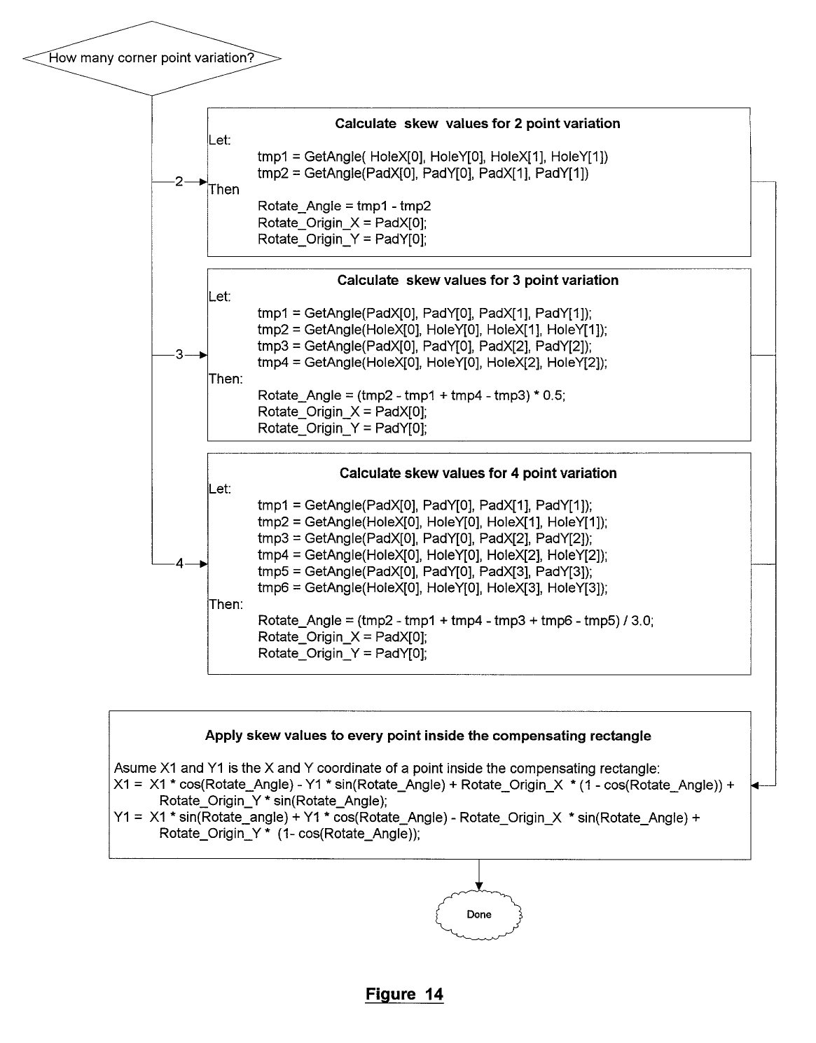

The yaw error compensation requires a four point variation. The compensating values for yaw error include Offset_X, Offset_Y, Factor_X and Factor_Y. These values can be obtained using formula 4A. The yaw compensating values must be applied to every target point. Assuming X1 and Y1 are the X and Y coordinates of a target point, formula 5A shows the method of applying yaw values. Both steps of obtaining and applying yaw values to a part program are shown in the software flow chart of FIG. 13.

Skew Error Compensation:

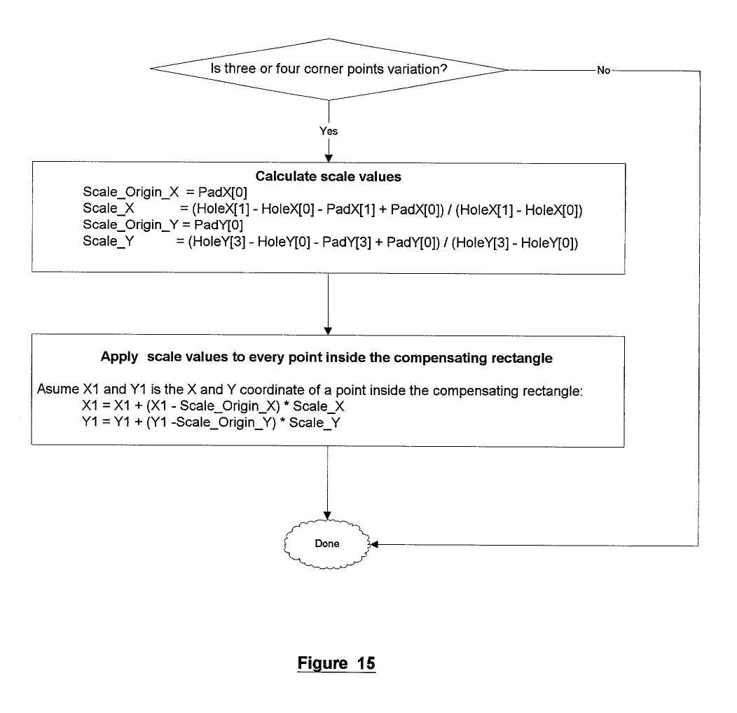

The skew error compensation requires a minimum of two point variations. The compensating values for yaw error include Rotate_Origin_X, Rotate_Origin_Y, and Rotate_Angle. For convenience of explanation, a function, named “GetAngle” is used. GetAngle is a function that takes coordinates of two points in the X-Y plane and returns the angle between the line that connects the two given points and the X-axis. The general format of the GetAngle function is Angle=GetAngle (Point1_X, Point1_Y, Point2_X, Point2_Y). The formulas for obtaining Rotate_Origin_X and Rotate_Origin_Y and Rotate_Angle vary depending on the number of corner point variations. Formula 6A shows the equation for obtaining skew error compensating values with two corner point variation; formula 7A shows the equation for obtaining skew error compensating values with three corner point variation; formula 8A shows the equation for obtaining skew error compensating values with four corner point variation. The skew compensating values must be applied to every target point. Assuming X1 and Y1 are the X and Y coordinates of a target point, formula 9A shows the method of applying skew values. Both steps of obtaining and applying skew values to a part program are outlined in the software flow chart shown in FIG. 14.

Scale Error Compensation:

The scale error compensation requires a minimum of three corner point variation. The compensating values for scale error include Scale_Origin_X, Scale Origin_Y, Scale_X and Scale_Y. Assuming HoleX[0] not equal to HoleX[1] and HoleY[0] not equal to HoleY[3], formula 10A shows the equations for obtaining the scale error compensating values. The scale error must be applied to every target point. Assuming X1 and Y1 are the X and Y coordinates of a target point, formula 11A shows the method of applying scale error values to a part program. Both steps of obtaining and applying scale error values to the part program are shown in the software flow chart of FIG. 15.

Offset Error Compensation:

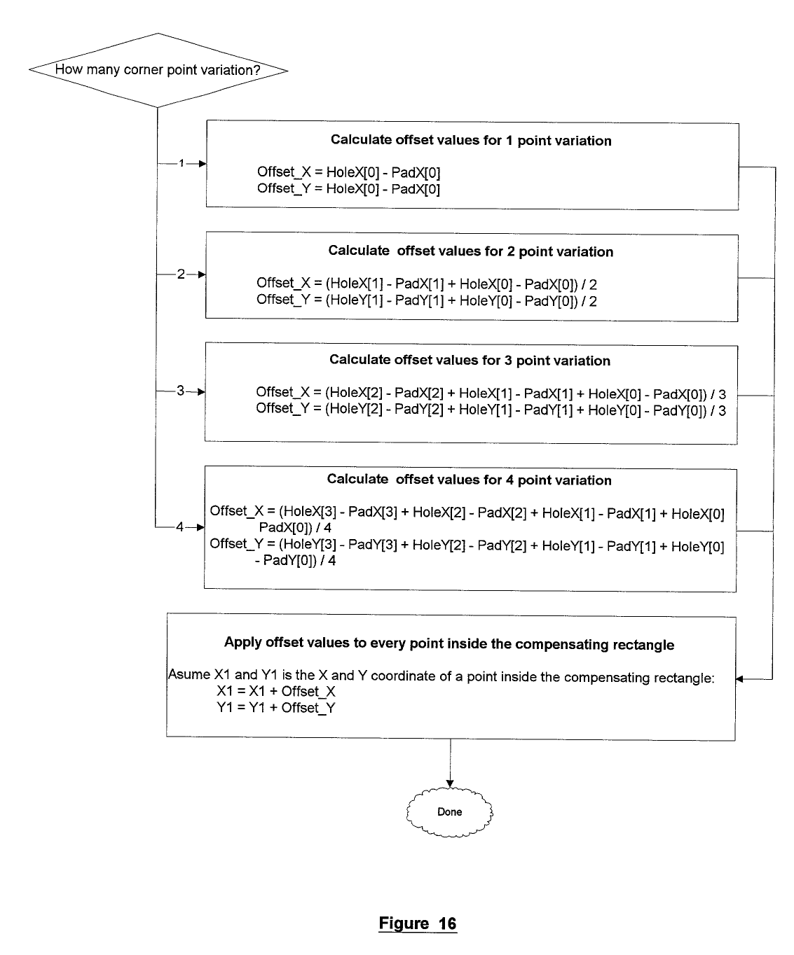

The offset error compensation requires a minimum of one point variation. The compensating values for offset error include Offset_X, and Offset_Y. The formulas for obtaining Offset_X and Offset_Y vary and depend on the number of corner point variations. Formula 12A shows the equation for obtaining the offset error compensating values with one corner point variation; formula 13A shows the equation for obtaining the offset error compensating values for two corner point variation; formula 14A shows the equation for obtaining offset error compensating values for three corner point variation and formula 15A shows the equations for obtaining the offset error compensating values with four corner point variation. The offset error compensating values also must be applied to every target point. Assuming X1 and Y1 are the X and Y coordinates of a target point, formula 16A shows the method of applying offset error values to a part program. Both steps of obtaining and applying offset error values to a part program are shown in the software flow chart of FIG. 16.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

TABLE I
Formula 1A

Refering to FIG. 4 a rectangle is defined with 3 points A, B, C and.

A(Xa, Ya)
B(Xb, Yb)
C(Xc, Yc)

Let:

Xmin = Min(Xa, Xb, Xc)
Ymin = Min(Ya, Yb, Yc)
Xmax = Max(Xa, Xb, Xc)
Ymax = Max(Ya, Yb, Yc) and
Half_Side_X = Abs((Xmax − Xmin)/2)
Half_Side_y = Abs((Ymax − Ymin)/2) and
Center_Y = (Xmax + Xmin) / 2
Center_Y = (Ymax + Ymin) / 2

The four points representation of this rectangle is:

| | |
|---|---|
| A(Center_X − Half_Side_X, | Center_Y − Half_Side_Y) |
| B(Center_X + Half_Side_X, | Center_Y − Half_Side_Y) |
| C(Center_X + Half_Side_X, | Center_Y + Half_Side_Y) |
| D(Center_X − Half_Side_X, | Center_Y + Half_Side_Y) |

Formula 2A

Offset_X = PadX[0]
Offset_Y = PadY[0]
Factor_X = (PadX[3] − HoleX[3] − PadX[0] + HoleX[0] + PadX[2] − HoleX[2] − PadX[1] + HoleX[1]) /

(PadY[2] − PadY[1] + PadY[3] − PadY[0])

Factor_Y = (PadY[1] − HoleY[1] − PadY[0] + HoleY[0] + PadY[2] − HoleY[2] − PadY[3] + HoleY[3]) /

(PadX[1] − PadX[0] + PadX[2] − PadX[3])

Formula 3A

X1 = X1 − (Y1 − Offset_Y) * Factor_X
Y1 = Y1 − (X1 − Offset_X) * Factor_Y

Formula 4A

Offset_X = (PadX[0] + PadX[1] + PadX[2] + PadX[3]) / 4
Offset_Y = (PadY[0] + PadY[1] + PadY[2] + PadY[3]) / 4
Factor_X = (HoleX[2] − HoleX[3] − HoleX[1] + HoleX[0]) / (PadY[2] − PadY[1] + PadY[3] − PadY[0])
Factor_Y = (HoleY[2] − HoleY[1] − HoleY[3] + HoleY[0]) / (PadX[1] − PadX[0] + PadX[2] − PadX[3])

Formula 5A

| | | |
|---|---|---|
| if (Y1 > Offset_Y) | X1 = X1 + (Y1 − Offset_Y) * Factor_X | and |
| if (Y1 < Offset_Y) | X1 = X1 − (Y1 − Offset_Y) * Factor_X | and |
| if (Y1 = Offset_Y) | X1 = X1 | |
| if (X1 > Offset_X) | Y1 = Y1 + (X1 − Offset_X) * Factor_Y | and |
| if (X1 < Offset_X) | Y1 = Y1 − (X1 − Offset_X) * Factor_Y | and |
| if (X1 = Offset_X) | Y1 = Y1 | |

Formula 6A

Let:

tmp1 = GetAngle( HoleX[0], HoleY[0], HoleX[1], HoleY[1])
tmp2 = GetAngle(PadX[0], PadY[0], PadX[1], PadY[1])

Then

Rotate_Angle = tmp1 − tmp2
Rotate_Origin_X = PadX[0];
Rotate_Origin_Y = PadY[0];

Formula 7A

Let:

tmp1 = GetAngle(PadX[0], PadY[0], PadX[1], PadY[1);
tmp2 = GetAngle(HoleX[0], HoleY[0], HoleX[1], HoleY[1]);
tmp3 = GetAngle(PadX[0], PadY[0], PadX[2], PadY[2]);
tmp4 = GetAngle(HoleX[0], HoleY[0], HoleX[2], HoleY[2]);

Then:

Rotate_Angle = (tmp2 − tmp1 + tmp4 − tmp3) * 0.5;
Rotate_Origin_X = PadX[0];
Rotate_Origin_Y = PadY[0];

Formula 8A

Let:

tmp1 = GetAngle(PadX[0], PadY[0], PadX[1], PadY[1]);
tmp2 = GetAngle(HoleX[0], HoleY[0], HoleX[1], HoleY[1]);
tmp3 = GetAngle(PadX[0], PadY[0], PadX[2], PadY[2]);
tmp4 = GetAngle(HoleX[0], HoleY[0], HoleX[2], HoleY[2]);
tmp5 = GetAngle(PadX[0], PadY[0], PadX[3], PadY[3]);
tmp6 = GetAngle(HoleX[0], HoleY[0], HoleX[3], HoleY[3]);

Then:

Rotate_Angle = (tmp2 − tmp1 + tmp4 − tmp3 + tmp6 − tmp5) / 3.0;
Rotate_Origin_X = PadX[0];
Rotate_Origin_Y = PadY[0];

Formula 9A

X1 = X1 * cos(Rotate_Angle) − Y1 * sin(Rotate_Angle) + Rotate_Origin_X * (1 − cos(Rotate_Angle)) +

Rotate_Origin_Y * sin(Rotate_Angle);

Y1 = X1 * sin(Rotate_angle) + Y1 * cos(Rotate_Angle) − Rotate_Origin_X * sin(Rotate_Angle) + Rotate_Origin_Y *

(1 − cos(Rotate_Angle));

Formula 10A

Scale_Origin_X = PadX[0]
Scale_X = (HoleX[1] − HoleX[0] − PadX[1] + PadX[0]) / (HoleX[1] − HoleX[0])
Scale_Origin_Y = PadY[0]
Scale_Y = (HoleY[3] − HoleY[0] − PadY[3] + PadY[0]) / (HoleY[3] − HoleY[0])

Formula 11A

X1 = X1 + (X1 − Scale_Origin_X) * Scale_X
Y1 = Y1 + (Y1 − Scale_Origin_Y) * Scale_Y

Formula 12A

Offset_X = HoleX[0] − PadX[0]
Offset_Y = HoleX[0] − PadX[0]

Formula 13A

Offset_X = (HoleX[1] − PadX[1] + HoleX[0] − PadX[0]) / 2
Offset_Y = (HoleY[1] − PadY[1] + HoleY[0] − PadY[0]) / 2

Formula 14A

Offset_X = (HoleX[2] − PadX[2] + HoleX[1] − PadX[1] + HoleX[0] − PadX[0]) / 3
Offset_Y = (HoleY[2] − PadY[2] + HoleY[1] − PadY[1] + HoleY[0] − PadY[0]) / 3

Formula 15A

Offset_X = (HoleX[3] − PadX[3] + HoleX[2] − PadX[2] + HoleX[1] − PadX[1] + HoleX[0] − PadX[0]) / 4
Offset_Y = (HoleY[3] − PadY[3] + HoleY[2] − PadY[2] + HoleY[1] − PadY[1] + HoleY[0] − PadY[0]) / 4

Formula 16A

X1 = X1 + Offset_X
Y1 = Y1 + Offset_Y

What is claimed is:

1. A method of compensating position commands in a manufacturing system having a coordinate system comprising the steps of:
determining an ideal location of four points on a work piece thereby defining a compensating rectangle having an interior;
measuring a location of four points on a work piece thereby defining an actual rectangle;
calculating one or more compensation values between the four points defining the compensating rectangle and the four points defining the actual rectangle from a group of compensation types; and,
applying the one or more compensation values to position commands corresponding to points located in the interior of the compensating rectangle.

2. The method of claim 1 wherein said compensation type is selected from the group consisting of squareness compensation, yaw compensation, skew compensation, scale compensation and offset compensation.

3. The method of claim 1 in further comprising the steps of:
determining a number of the four points defining the compensating rectangle and the four points defining the actual rectangle which require compensation; and
applying one or more compensation types from the group of compensation types based upon the number of points which require compensation.

4. The method of claim 1 further comprising the steps of:
selecting three construction points on the work piece; and
setting the ideal location of the four points on the work piece to be vertices of a constructed rectangle with sides parallel to axes of the coordinate system, the sides of the constructed rectangle containing the three construction points.

5. A method of compensating position commands in a manufacturing system comprising the steps of:
determining an ideal location of multiple sets of four points on a work piece thereby defining multiple compensating rectangles, each having an interior;
measuring a location of multiple sets of four points on a work piece thereby defining an actual rectangle corresponding to each compensating rectangle;
calculating one or more compensation values between the set of four points defining each compensating rectangle and the set of four points defining the actual rectangle corresponding to the compensation rectangle from a group of compensation types; and,
applying the one or more compensation values to position commands corresponding to points located in the interior of each compensating rectangle.

6. The method of claim 5 wherein said compensation type is selected from the group consisting of squareness compensation, yaw compensation, skew compensation, scale compensation and offset compensation.
